(19) United States
(12) Patent Application Publication
(10) Pub. No.: US 2009/0320478 A1
(43) Pub. Date: Dec. 31, 2009

(54) Reduced boundary layer separation steam jet air ejector assembly and method

(75) Inventor: Robert Alan Head, San Jose, CA (US)

Correspondence Address: HARNESS, DICKEY & PIERCE, P.L.C., P.O. BOX 8910, RESTON, VA, 20195, US

(73) Assignee: General Electric Company

(21) Appl. No.: 11/325,646

(22) Filed: Jan. 4, 2006

(51) Int. Cl. F01K 19/00; B01D 19/00

(52) U.S. Cl. 60/657

(57) ABSTRACT

A steam jet air ejector and a method for improving the performance of a steam jet air ejector in a nuclear reactor, the boundary layer separation reduction assembly for the steam jet air ejector includes a discharge diffuser including a plurality of vacuum ports positioned along an inner surface of the discharge diffuser and a vacuum source coupled to the vacuum ports.

### FIELD

The present disclosure relates to steam jet air ejectors and more specifically, to a steam jet air ejector for use in a nuclear power plant.

### BACKGROUND

The statements in this section merely provide background information related to the present disclosure and may not constitute prior art.

Steam jet air ejectors (SJAE) are often used in nuclear power plants to remove water vapor and other non-condensable gases from main condensers that can reduce the heat transfer surface area of the condenser. Steam jet air ejectors provide a relatively low-cost and low-maintenance vacuum pump for removing these non-condensable gases from a power plant's main turbine condenser to improve the efficiency of the condenser. These ejectors operate on an ejector-venturi principle that utilize the momentum of a high-velocity steam jet to move air and other gases from a connecting pipe or vessel, such as a condenser. Ejectors typically include an actuating fluid, such as a gas, vapor, or liquid, a secondary fluid, a suction chamber, a nozzle, an inlet diffuser, a throat, and an outlet diffuser. The actuating fluid is expanded from an initial pressure level to a pressure level equivalent to that of the secondary fluid. During the process of expansion, the actuating fluid is accelerated from an initial velocity upon entering the ejector to higher velocity.

Generally, the flow capacity of an ejector is fixed within an operating range by its dimensions. Within this range, the capacity can vary as function of the steam flow, absolute pressure at the suction inlet, discharge pressure, and cooling water temperature. In operation, high cooling water temperatures, high condenser air leakage, and/or high discharge pressure at the ejector discharge can reduce the capacity of the ejector when boundary layer separation occurs within the ejector. During periods of boundary layer separation, the capacity and efficiency of the ejector decline and as a result, the amount of non-condensable gas flow removed from the condenser decreases. As the removal of non-condensable gas from the condenser is critical to power plant performance, the reduced flow through the ejector can lead to reduced power plant output or possible power plant shut down when the ejector fails to adequately remove the non-condensable gases from the condenser.

Traditionally, when reductions to condenser efficiency are identified, the power plant operator is required to reduce the power plant capacity and initiate maintenance procedures to locate possible sources of the decreased efficiency, to clean or repair possible sources internally and with related or coupled equipment and systems. As such, improvements in the operation and efficiency of the steam jet air ejector as used in a power plant can reduce maintenance costs, reduce power generation limitations, and improve the efficiency of power generation.

### SUMMARY

The inventor hereof has succeeded at designing a steam jet air ejector assembly and method having improved stability and efficiency under conditions of conventional instability and/or stalling created by boundary layer separation in the diverging discharge nozzle of a steam jet air ejector as used in a power plant.

According to one aspect, a boundary layer separation reduction assembly for a steam jet air ejector includes a discharge diffuser having an inner surface and a plurality of vacuum ports positioned along the inner surface and a vacuum source coupled to the vacuum ports.

According to another aspect, in a power plant, a steam jet air ejector includes a steam nozzle coupled to a steam supply for receiving high-pressure steam and a suction inlet for receiving non-condensable gas from a condenser. The ejector also includes a discharge diffuser having an inner surface and a plurality of vacuum ports positioned along the inner surface and a vacuum plenum. The vacuum plenum is positioned around an exterior surface of the discharge diffuser and about the vacuum ports and couples the vacuum ports to a vacuum source. The vacuum plenum and vacuum ports are configured for creating a vacuum through the vacuum ports for withdrawing a portion of a fluid flow in the discharge diffuser.

According to yet another aspect, a method for improving the performance of a steam jet air ejector includes withdrawing a portion of a flow in a discharge diffuser nozzle of the steam jet air ejector through ports located in the discharge diffuser nozzle.

According to still another aspect, a method of modifying a steam jet air ejector includes forming a plurality of holes in a diffuser discharge nozzle of the steam jet air ejector, attaching a vacuum plenum around an outer surface of the diffuser discharge nozzle and about the holes, and coupling the vacuum plenum to a vacuum source.

Further aspects of the present invention will be in part apparent and in part pointed out below. It should be understood that various aspects of the invention may be implemented individually or in combination with one another. It should also be understood that the detailed description and drawings, while indicating certain exemplary embodiments of the invention, are intended for purposes of illustration only and should not be construed as limiting the scope of the invention.

### BRIEF DESCRIPTION OF THE DRAWINGS

FIG. 1 is a sectioned side view of a single-stage steam jet air ejector having a boundary layer separation reduction assembly according one embodiment of the invention.

FIG. 2 is a sectioned side view of a two-stage steam jet air ejector with reduced boundary layer separation assemblies according to another embodiment of the invention.

FIG. 3 is a flow diagram of a method of modifying a steam jet air ejector according to another embodiment of the invention.

FIG. 4 is a system schematic of a nuclear power generation system utilizing two steam jet air ejectors according to another embodiment of the invention.

FIG. 5 is a block diagram of a computer system that can be used to implement a method and apparatus embodying a boundary layer separation flow controller according to one embodiment of the invention.

It should be understood that throughout the drawings, corresponding reference numerals indicate like or corresponding parts and features.

### DETAILED DESCRIPTION

The following description is merely exemplary in nature and is not intended to limit the present disclosure, applications, or uses.

In one embodiment, a boundary layer separation reduction assembly for a steam jet air ejector has a discharge diffuser including a plurality of vacuum ports positioned along an inner surface of the discharge diffuser and a vacuum source coupled to the vacuum ports. In some embodiments, a steam jet air ejector can include a boundary layer separation reduction assembly configured to remove a portion of the fluid flow along the inner surface of the discharge diffuser.

In some embodiments, the vacuum source and vacuum ports are configured for creating a vacuum within the vacuum ports for withdrawing a portion of a flow within the diffuser through the ports and out of the diffuser. By removing a portion of the flow along the inner surface of the discharge diffuser, boundary layer separation can be reduced or thinned thereby increasing the attachment of the fluid flow to the diverging wall or surface within the discharge diffuser.

In some embodiments, a vacuum plenum can be positioned around an exterior surface of the discharge diffuser and about the vacuum ports to couple the vacuum source to the vacuum ports. In other embodiments, the discharge diffuser can be formed to include a hollow cavity formed between the inner surface and an outer surface. The hollow cavity is coupled via a vacuum intake port to the vacuum source. In such embodiments, the vacuum ports fluidly couple the inner surface to the hollow cavity and therefore to the vacuum source for removing a portion of the fluid flowing along the inner surface of the discharge diffuser.

In other embodiments, a flow control device can be coupled between the vacuum source and the vacuum plenum and configured for adjusting the amount of vacuum and flow received by the vacuum plenum and therefore the vacuum ports from the vacuum source. The flow control device can be any type of flow device or pressure device such as a valve, by way of example. A flow control device controller can also be coupled to the flow control device for controlling the flow control device and the amount of vacuum through the vacuum ports. For example, the flow control device controller can be a simple controller, a control computer, or a portion or module of a larger system or operational system. Generally, the flow control device controller provides a signal to the controller for controlling the variable rate of flow and therefore the vacuum level and flow through the coupled vacuum ports. One or more operational characteristic sensors or other operational systems can also be coupled to the flow control device controller, the sensor associated with an operation affecting the performance of the steam jet air ejector and providing a signal to the flow control device controller indicative of the operational characteristic such as a flow, a non-condensable flow rate from a condenser, a pressure such as condenser pressure, a cooling water temperature in an associated condenser, an air linkage, an air pressure such as the backpressure at the discharge of the steam jet air ejector, and a vacuum level, by way of example. One or more of these characteristics can be provided from existing sensors or systems or can be added specifically for controlling the boundary layer separation reduction vacuum within the vacuum ports.

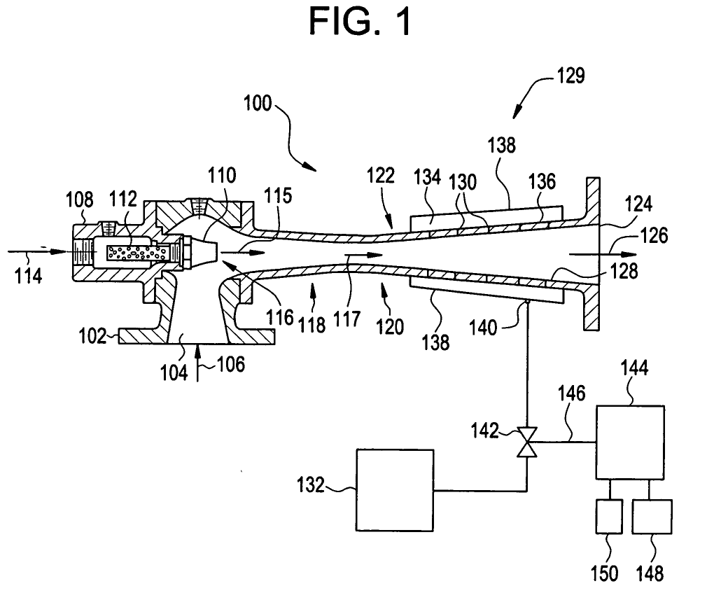

Referring now to FIG. 1, a steam jet air ejector 100 is illustrated as one exemplary embodiment. A suction head 102 includes an suction input adaptor 104 for receiving fluid flow 106 (sometimes referred to as the actuating fluid) from a fluid source (not shown). The fluid flow 106 is generally a low-pressure and low flow fluid. In one exemplary application, the fluid source is a condenser in a power plant and the fluid flow 106 includes non-condensable fluid within the condenser.

A steam chest 108 includes a steam nozzle 110, a steam strainer 112 and is adapted for receiving high-pressure steam 114 from a high-pressure steam source (not shown). The high-pressure steam 114, sometimes referred to as the motive steam, enters the steam chest 108 and is strained by the steam strainer 112 before entering a suction chamber 116 at the steam nozzle 110. The steam nozzle 110 converts the energy of the high-pressure steam 114 into a velocity flow 115. Upon entering the suction chamber 116, the velocity flow 115 mixes with the receiving fluid flow 106 and moves through structural portions of the steam jet air ejector 100 including an inlet diffuser 118, a combining throat 120, and a discharge diffuser 122, and out of the ejector 100 at a discharge outlet 124 as a discharge flow 126. It should be understood that the inlet diffuser 118, a combining throat 120, and a discharge diffuser 122 can be regions within the steam jet air ejector 100 and may not be separate structures per se. The inlet diffuser 118 mixes the velocity flow 115 with the receiving fluid flow 106 and the energy of the velocity flow 115 is converted to pressure. After flowing through the combining throat 120, the combined flow 117 enters the discharge diffuser 122 that further reduces the velocity of the combined flow 117 to a level that completes the conversion of the velocity energy to pressure energy.

Upon entering the discharge diffuser 122, a portion of the combined flow 117 flows along inner surface 128 that includes a boundary layer separation reduction assembly 129. The boundary layer separation reduction assembly 129 includes a plurality of ports 130. The ports 130 can be holes that are fluidly coupled to a vacuum source 132 such that a vacuum flow is produced in the ports 130. It should be understood that a vacuum as described herein is a pressure that is less than the pressure within the discharge diffuser 122 such that at least a portion of any fluid flowing in the discharge diffuser 122 is extracted or otherwise withdrawn through the ports 130 as a function of a fluid flow resulting from the pressure created in the ports being less than the pressure in a proximate portion of the discharge diffuser 122.

The ports 130 can be holes that have been formed such as by cutting or drilling and can be circumferentially and axially positioned along, at least a portion, of the inner surface 128 of the discharge diffuser 122. A vacuum cavity 134 can be formed between the inner surface 128 and an outer surface 136. For example, the vacuum cavity 134 can be defined by a plenum 138 or manifold attached around the outer surface and about the ports 130 coupled to the inner surface 128. The vacuum cavity 134 couples the vacuum source 132 to a plurality of ports 130 for delivering the vacuum to the ports 130 and for distributing the vacuum among the ports 130. The vacuum cavity 134 can be configured to include baffles (not shown), channels, or other structure to aid in coupling the vacuum flow to one or more ports 130. One or more vacuum inlets 140 can couple the vacuum cavity 134 to the vacuum source 132. In other embodiments, one or more vacuum sources 132 can be directly coupled to one or more ports 130 without utilizing a vacuum cavity 134.

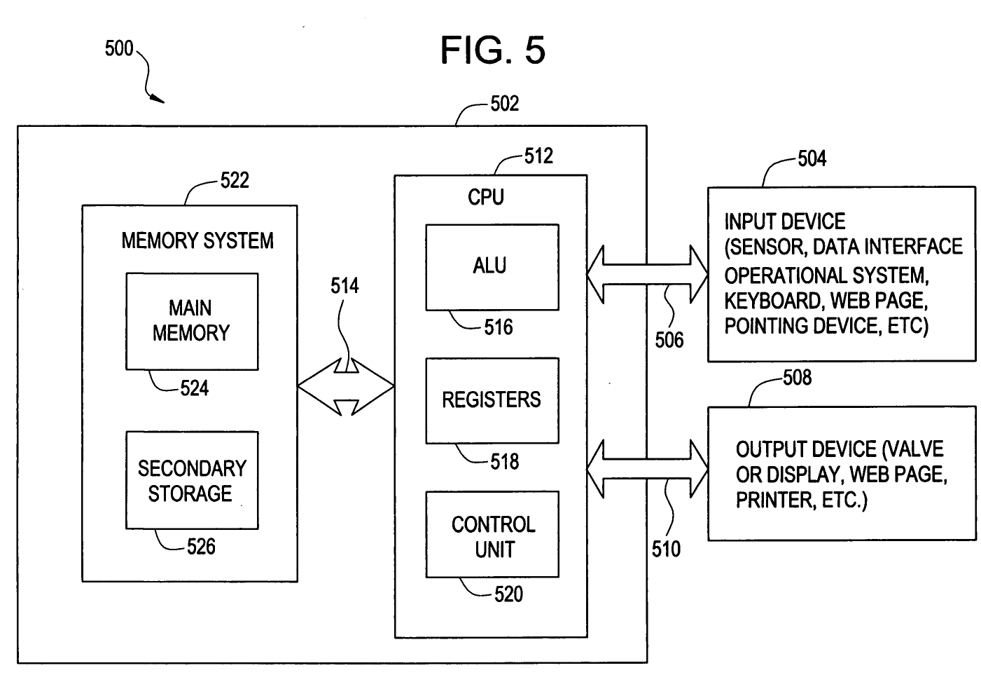

In some embodiments, a flow control device 142, such as a valve, can be positioned within the vacuum flow between the vacuum source 132 and the ports 130 for adjusting the amount of vacuum delivered to the ports 130. The flow control device 142 can be any suitable valve or limiting device and in some examples is a pressure or flow control device. The flow control device 142 can be operable in response to a flow control device controller 144 such as a flow control device control system or processor. The flow control device controller 144 can generate a flow control device control signal 146 for controlling the on-off, stepped, staged, or variable operation of the flow control device 142. The controller can be any type of control signal generating and controlling system, and can include a processor as described below with regard to FIG. 5, or can be a module or sub-system within another operational system. The flow control device controller 144 can receive input from sensors 148 or data from a power plant operational system 150. The flow control device controller 144 can be configured to receive one or more operational characteristic from either a sensor 148 or power plant operational system 150 and generate the flow control device control signal 146 as a function of the received operational characteristics. Examples of an operational characteristic from which the flow control device 142 can be controlled for controlling the pressure and flow of vacuum through the ports 130, include but are not limited to a pressure, a flow, a cooling water temperature in an associated condenser, an air linkage, an air pressure, and a vacuum level. In some embodiments, the controller 144 can be configured for controlling a rate of withdrawing fluid flow from within the discharge nozzle as a function of one or more of a condenser pressure, a non-condensable flow rate, a cooling water temperature, and a steam jet air ejector backpressure.

By monitoring one or more operational characteristics, the controller 144 can control the vacuum presented through each port 130 and therefore control the amount of combined fluid 117 extracted from along the inner surface 128 of the discharge diffuser. As such, the controller 144 can increase the extracted flow through the ports in conditions that would have otherwise resulted in boundary layer separation of the combined flow within the discharge diffuser and therefore loss of flow capacity of the steam jet air ejector 100. The vacuum level or flow extracted through ports 130 can be reduced or eliminated by operation of the flow control device 142 when operating conditions indicate that boundary layer separation is not likely to occur, thereby eliminating or minimizing any negative effect, that can result from withdrawal of a portion of the combined fluid 117 that would otherwise exit the discharge outlet 124 as discharge flow 126.

In another exemplary embodiment of the invention, a method for improving the performance of a steam jet air ejector includes withdrawing a portion of a flow, such as a fluid flow, in a discharge diffuser nozzle of the steam jet air ejector through ports located in the discharge diffuser nozzle. The ports can be through-holes positioned around an inner surface of the discharge diffuser nozzle of the steam jet air ejector.

The method can also include creating a vacuum for producing the withdrawing a portion of the flow through the ports and can include withdrawing, at least a portion of, the vacuum at an air suction inlet to the steam jet air ejector. This can also include creating a vacuum in a vacuum manifold positioned around an outer surface of the discharge diffuser nozzle and about the ports.

As noted above, the method can also include adjusting the withdrawing as a function of one or more operational characteristic and/or controlling a rate of withdrawing the fluid flow as a function of one or more of a condenser pressure, a non-condensable flow rate, a cooling water temperature, and a steam jet air ejector backpressure.

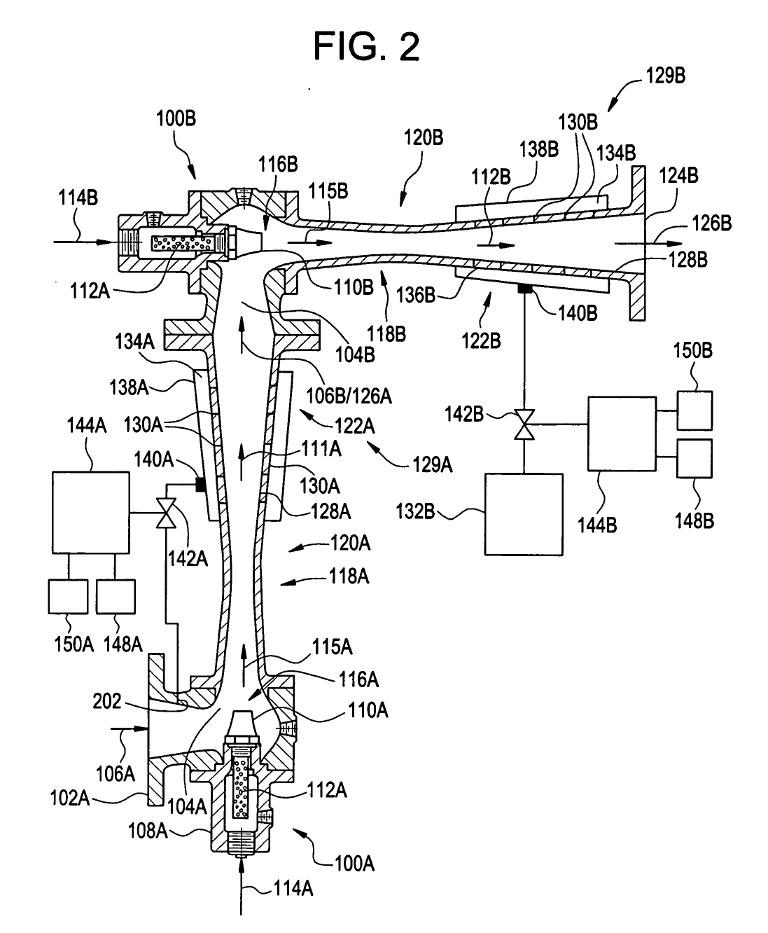

FIG. 2 illustrates a two-stage steam jet air ejector according to another exemplary embodiment having a first ejector 100A and a second ejector 100B. One or both of the first ejector 100A and second ejector 100B can be similar to the ejector described above with regard to FIG. 1 or may be different. For example, while both first ejector 100A and second ejector 100B are illustrated as being equipped with a boundary layer separation reduction assembly, only one of the two may be so equipped. Additionally, a third or more steam jet air ejector 100 may also be coupled in series even though FIG. 2 only illustrates two serially coupled ejectors.

As illustrated in this example, the first ejector 100A receives a fluid flow 106A from a fluid source such as a power plant condenser. The fluid 106A is combined within the suction chamber 116A with the high-pressure steam 114A that is delivered through steam strainer 112A and by steam nozzle 110A. The velocity flow 115A enters the inlet diffuser 118A and travels through the combining throat 120A to the discharge diffuser 122A having a first boundary layer separation reduction assembly 129A. The ports 130A of the first boundary layer separation reduction assembly 129A receive a vacuum from a vacuum source for withdrawing a portion of the fluid flow along the inner surface 128A to reduce boundary layer separation of the combined fluid flow within the discharge diffuser 122A. In this example, the vacuum source is a vacuum port 202 positioned at the suction head 102A of ejector 100A. The flow control device 142A is controlled by flow control device controller 144A in response to one or more operational characteristic as provided to the controller 144A from a sensor 148A or an operational system 150A. The discharge flow 126A exits the discharge outlet 124A as discharge flow 126A and enters the second ejector 100B through suction port 104B as fluid 106B.

In the second ejector 100B, the fluid 106B is combined within the suction chamber 116B with the high-pressure steam 114B that is delivered through steam strainer 112A and by steam nozzle 110B. The high-pressure steam 114B is illustrated as being from a separate steam source, but may be received from the same high-pressure steam source as high-pressure steam 114A. The velocity flow 115B enters the inlet diffuser 118B and travels through the combining throat 120B to the discharge diffuser 122B. A second boundary layer separation reduction assembly 129B includes ports 130B for receiving a vacuum from vacuum source 132B. The second boundary layer separation reduction assembly 129B is configured to withdraw a portion of the fluid flow along the inner surface 128B to reduce boundary layer separation of the combined fluid flow within the discharge diffuser 122B. The flow control device 142B is controlled by flow control device controller 144B in response to one or more operational characteristic as provided to the flow control device controller 144B from a sensor 148B or an operational system 150B. One or more sensors 148B or operational systems 150B can be the same as sensor 148A and operational system 150A. The discharge flow 126B exits the discharge outlet 126B as discharge flow 126B.

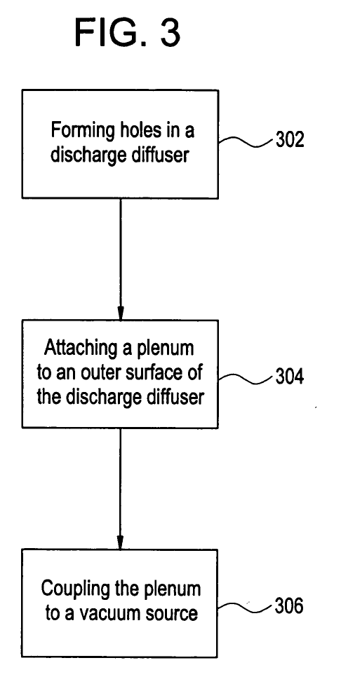

In another embodiment, as noted above an existing steam jet air ejector can be modified for improved performance by modifying the steam jet air ejector to be equipped with a boundary layer separation reduction assembly and system. FIG. 3 illustrates a flow chart for one exemplary embodiment of the method for modifying a steam jet air ejector. This method can also be understood by referring back to FIG. 1. As shown, the method 300 can begin in process 302 with the forming of holes 130 such as through holes to form vacuum ports on the inner surface 128 of the discharge diffuser 122. After the holes 130 are formed in 302, a vacuum plenum 138 or manifold is attached to the outer surface 136 of the discharge diffuser 122 and about the vacuum ports 130 in process 304. After the vacuum plenum 138 is attached to ensure a vacuum is formed at each port, the plenum 138 is coupled to a vacuum source 132 in 306 for providing vacuum within a cavity 134 of the vacuum plenum 138 and through each port 130 formed in process 302.

The ports or holes 130 can be formed by any applicable method or system, including drilling, punching, cutting or other suitable machining method. The holes 130 can also be formed during construction of the plenum 138 or cavity 134 such as by molding or casting. Generally, the holes 130 can be formed circumferentially and axially on the inner surface 128 of the discharge diffuser 122 (sometimes referred to as the diffuser discharge nozzle). The quantity, size and pattern of the formed holes 130 can vary and in some embodiments they can be determined by analysis of the flow patterns and the level of vacuum required to sufficiently reduce the boundary layer separation during critical operating conditions and in the presence of operational characteristics that result in boundary layer separation within the discharge diffuser 122.

In some embodiments, as addressed above, a flow control device, such as a flow control device 142, is coupled between the vacuum plenum 138 and/or holes 130 and the vacuum source 132. The flow control device can be a bi-state device, a multi-state device or a variable flow or vacuum level device configured for adjusting the vacuum within the vacuum plenum and through the holes 130. A flow control device controller 144 can be coupled to the flow control device and configured for receiving one or more operational characteristics from sensors 148 or other operational systems 150 and upon which control decisions and signals generated.

One or more of the boundary layer separation reduction assemblies or steam jet air ejectors equipment with such assemblies can be deployed in a power plant generation system to aid in the improved removal of non-condensable gases from a condenser, and therefore the improved efficiency of the condenser and the power plant.

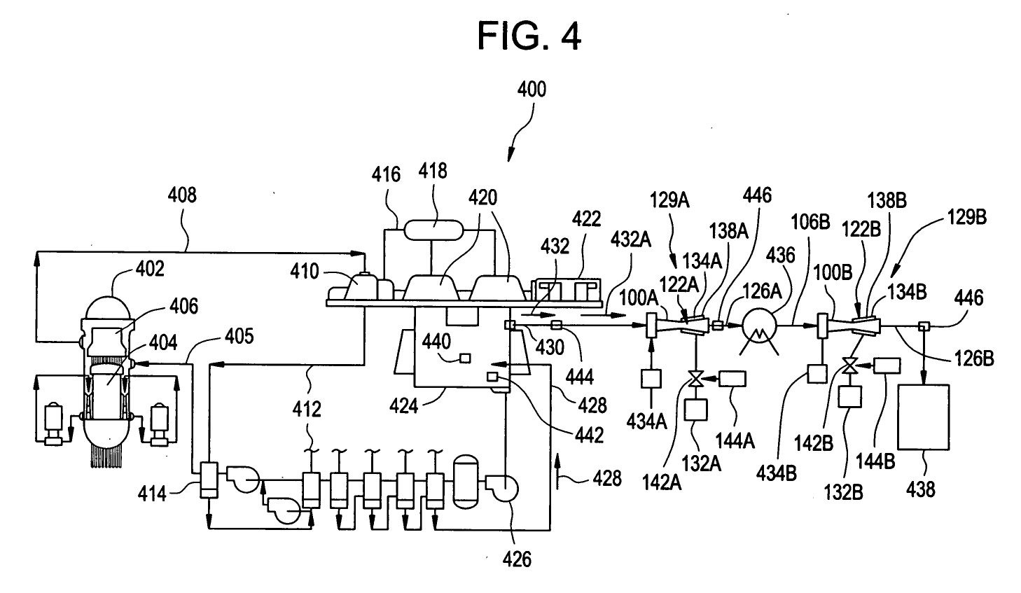

One exemplary embodiment of a power plant and power generation system utilizing a steam jet air ejector with a boundary layer separation reduction assembly is illustrated in FIG. 4. In a power plant 400, a reactor pressure vessel 402 includes a reactor core 404 for generating heat and producing steam 408 from feed water 405. Separators and dryers 406 extract the steam 408 and forward the steam 408 to a high-pressure turbine 410. The high-pressure turbine 410 returns extracted steam 412 to a heater 414 for condensation. Additionally, secondary steam 416 is provided to a moisture separator and heater 418 and then to a low-pressure turbine 420. The high-pressure turbine 410 and low-pressure turbine 420 are coupled to a generator 422 for producing electricity.

A condenser 424 receives the steam and condenses the steam 416 for recycling through the power generation process and provides the condensed steam to a pump 426. The condenser 424 receives cooling water 428 for condensing the steam. A non-condensable gas outlet 430 extracts non-condensable gas 432 from within the condenser 424 and provides the non-condensable gas 432A to the first ejector 100A. This is in response to the pumping action generated by first ejector 100A and second ejector 100B. A high-pressure steam source 434A provides steam to the first ejector 100A that is combined with non-condensable gas 432A and provided to first discharge diffuser 122A. The combined fluid flow within the first discharge diffuser 122A pass ports 130A (not shown) that include a vacuum level and flow as provided by vacuum source 132A through vacuum control device 142A in response to flow control device controller 144A. After passing the first boundary layer separation reduction assembly 129A in the first discharge diffuser 122A, the flow is discharged from the first ejector 100A as first discharge flow 126A.

A heat exchanger 436 is positioned and configured for condensing and removing the steam discharged from the first stage air ejector 100A. By removing the steam, the steam load is reduced in the fluid flow 106B that is presented to the second stage ejector 100B. In this manner, the second stage ejector 100B is only required to process non-condensable gases received from the first stage ejector 100A.

The fluid flow 106B enters the second ejector 100B. A high-pressure steam source 434B provides steam to the second ejector 100B that is combined with fluid flow 106B and provided to second discharge diffuser 122B. The combined fluid flow within the second discharge diffuser 122B pass the second boundary layer separation reduction assembly 129B that include a vacuum level and flow as provided by vacuum source 132B through vacuum control device 142B in response to flow control device controller 144B. After passing the boundary layer separation reduction assembly 129B in the second discharge diffuser 122B, the flow is discharged from the second ejector 100B as second discharge flow 126B. The second discharge flow 126 is then provided to a offgas system 438. The offgas system 438 can be any type of system and can include, by way of example, a system to collect, control, process, delay, and/or dispose of gaseous radioactive waste and hydrogen generated during normal operations of the nuclear reactor.

The flow control device controller 142A and flow control device controller 142B can receive sensor input from a variety of sensors including a condenser pressure sensor 440, a condenser cooling water temperature 442, a non-condensable fluid flow rate sensor 444, a steam jet air ejector backpressure sensor 446, by way of example. Additional sensors and related operational characteristics can also be provided to the flow control device controllers 142A and/or 142B even though not illustrated in FIG. 4. For example, additional sensors can provide operational characteristics such as a pressure, a flow, a cooling water temperature in an associated condenser, an air linkage, an air pressure, a vacuum level.

Referring now to FIG. 5, an operating environment for a flow control device controller, such as controller 144, for a boundary layer separation reduction assembly (such as) is illustrated in one embodiment of as computer system 500. The computer system 500 includes a computer 502 that comprises at least one high speed processing unit (CPU) 512, in conjunction with a memory system 522, at least one bus structure 514, an input device 504 coupled via an input interface 506, and an output device 508 coupled by an output interface 510.

The illustrated CPU 512 is of familiar design and includes an arithmetic logic unit (ALU) 516 for performing computations, a collection of registers 518 for temporary storage of data and instructions, and a control unit 520 for controlling operation of the system 500. Any of a variety of processors, including at least those from Digital Equipment, Sun, MIPS, Motorola, NEC, Intel, Cyrix, AMD, HP, and Nexgen, are equally preferred for the CPU 512. The illustrated embodiment of the invention operates on an operating system designed to be portable to any of these processing platforms.

The memory system 522 generally includes high-speed main memory 524 such as random access memory (RAM) and read only memory (ROM) semiconductor devices, and secondary storage 526 such as floppy disks, hard disks, tape, CD-ROM, flash memory, etc. and other devices that store data using electrical, magnetic, optical or other recording media. The main memory 524 also can include video display memory for displaying images through a display device. Those skilled in the art will recognize that the memory system 522 can comprise a variety of alternative components having a variety of storage capacities. One or more operational characteristic as described above can be stored in memory system 522.

The input devices 504 and output devices 508 also are familiar. The input device 504 can comprise a keyboard, a mouse, a physical transducer (e.g. a microphone or as one or more sensors as described above), by way of example. The output device 508 can comprise a display, a printer, a transducer (e.g., a speaker), etc. Some devices, such as a network adapter or a modem, can be used as input and/or output devices.

As is familiar to those skilled in the art, the computer system 500 further includes an operating system and at least one application program. The operating system is the set of software which controls the computer system's operation and the allocation of resources. The application program is the set of software that performs a task desired by the user, using computer resources made available through the operating system. Both are resident in the illustrated memory system 522.

In accordance with the practices of persons skilled in the art of computer programming, the present invention is described below with reference to symbolic representations of operations that are performed by the computer system 500. Such operations are sometimes referred to as being computer-executed. It will be appreciated that the operations which are symbolically represented include the manipulation by the CPU 512 of electrical signals representing data bits and the maintenance of data bits at memory locations in the memory system 522, as well as other processing of signals. The memory locations where data bits are maintained are physical locations that have particular electrical, magnetic, or optical properties corresponding to the data bits. The invention can be implemented in a program or programs, comprising a series of instructions stored on a computer-readable medium. The computer-readable medium can be any of the devices, or a combination of the devices, described above in connection with the memory system 522.

It should be understood that the illustrated steam jet air ejectors and modifications thereof can vary depending on the structure and positioning and design of the boundary layer separation reduction assembly and or the steam jet air ejector itself. Other such implementations of a boundary layer separation reduction assembly and/or steam jet air ejector, consistent with these teachings, are also considered within the scope of the present disclosure.

When describing elements or features of the present invention or embodiments thereof, the articles “a”, “an”, “the”, and “said” are intended to mean that there are one or more of the elements or features. The terms “comprising”, “including”, and “having” are intended to be inclusive and mean that there may be additional elements or features beyond those specifically described.

Those skilled in the art will recognize that various changes can be made to the exemplary embodiments and implementations described above without departing from the scope of the invention. Accordingly, all matter contained in the above description or shown in the accompanying drawings should be interpreted as illustrative and not in a limiting sense.

It is further to be understood that the processes or steps described herein are not to be construed as necessarily requiring their performance in the particular order discussed or illustrated. It is also to be understood that additional or alternative processes or steps may be employed.

1-8. (canceled)

9. In a power plant, a steam jet air ejector comprising:
a steam nozzle coupled to a steam supply for receiving high-pressure steam, the steam nozzle having a narrowing cross-section so as to increase the velocity of the received steam;
a suction inlet for receiving non-condensable gas from a condenser;
a discharge diffuser having an inner surface and a plurality of vacuum ports positioned along the inner surface;
a vacuum plenum positioned around an exterior surface of the discharge diffuser and about the vacuum ports and coupling the vacuum ports to a vacuum source, the vacuum plenum and vacuum ports configured for creating a vacuum through the vacuum ports for withdrawing a portion of a fluid flow in the discharge diffuser; and
a flow control device coupled between the vacuum source and the vacuum plenum and configured for adjusting the amount of vacuum and flow.

10. The steam jet air ejector of claim 9 wherein the vacuum ports include through holes circumferentially and axially positioned within the discharge diffuser.

11. The steam jet air ejector of claim 9, further comprising a suction head defining the suction inlet and the vacuum source.

12. (canceled)

13. The steam jet air ejector of claim 9, further comprising a flow controller for controlling the flow control device and the amount of vacuum at the vacuum ports as a function of an operational characteristic, the flow controller coupled to a sensor for receiving the operational characteristic.

14. The steam jet air ejector of claim 13 wherein the flow controller includes a processor responsive to computer instructions and configured for receiving the operational characteristic and generating a control signal, and a flow or pressure valve positioned between the vacuum source and the vacuum ports configured for receiving the control signal and for regulating the vacuum through the ports.

15. The steam jet air ejector of claim 14 wherein the flow controller is configured for controlling a rate of withdrawing fluid flow from within the discharge diffuser as a function of one or more of a condenser pressure, a non-condensable flow rate, a cooling water temperature, and a steam jet air ejector backpressure.

16. The steam jet air ejector of claim 13 wherein the sensor is configured for sensing one or more operational characteristics including one or more of a pressure, a flow, a cooling water temperature in an associated condenser, an air linkage, an air pressure, and a vacuum level.

17. A method for improving the performance of a steam jet air ejector including a steam nozzle coupled to a steam supply for receiving high-pressure steam, the steam nozzle having a narrowing cross-section so as to increase the velocity of the received steam, a suction inlet for receiving non-condensable gas from a condenser, and a discharge diffuser coupled to the suction inlet, the method comprising:
withdrawing a portion of a flow in the discharge diffuser of the steam jet air ejector through ports located in the discharge diffuser with a vacuum source; and
controlling a rate of withdrawing the flow from the discharge diffuser through the ports with a flow control device coupled between the vacuum source and the discharge diffuser.

18. The method of claim 17, further comprising creating a vacuum in the ports for producing the vacuum and withdrawing a portion of the flow.

19. The method of claim 18 wherein creating a vacuum includes creating the vacuum at an air suction inlet to the steam jet air ejector.

20. The method of claim 18 wherein creating a vacuum includes creating a vacuum in a vacuum manifold positioned around an outer surface of the discharge diffuser and about the ports.

21. The method of claim 17, further comprising adjusting the withdrawing as a function of an operational characteristic.

22. The method of claim 21 wherein the operational characteristic is one or more of pressure, flow, cooling water temperature in an associated condenser, air linkage, air pressure, and vacuum level.

23. The method of claim 17 wherein the ports are through-holes positioned around an inner surface of the discharge diffuser.

24. The method of claim 17 wherein the flow is a flow of a fluid.

25. The method of claim 24 wherein controlling a rate of withdrawing the fluid flow includes increasing the fluid flow rate as a function of one or more of a condenser pressure, a non-condensable flow rate, a cooling water temperature, and a steam jet air ejector backpressure.

26. The method of claim 17 wherein creating a vacuum includes creating a vacuum in an inner cavity defined between an inner surface and an outer surface of the discharge diffuser.

27. A method of modifying a steam jet air ejector including a steam nozzle coupled to a steam supply for receiving high-pressure steam, the steam nozzle having a narrowing cross-section so as to increase the velocity of the received steam, a suction inlet for receiving non-condensable gas from a condenser, and a discharge diffuser coupled to the suction inlet, the method comprising:
forming a plurality of holes in the discharge diffuser of the steam jet air ejector;
attaching a vacuum plenum around an outer surface of the discharge diffuser and about the holes;
coupling the vacuum plenum to a vacuum source; and
coupling a flow control device between the vacuum plenum and the vacuum source, the flow control device configured for adjusting the vacuum within the vacuum plenum and about the holes.

28. The method of claim 27 wherein forming the holes includes drilling the holes circumferentially and axially in an inner surface of the discharge diffuser.

29. (canceled)

30. The method of claim 27, further comprising coupling a flow control device controller to the flow control device and coupling an operational characteristic sensor to the flow control device controller.

31. The steam jet air ejector of claim 9, further comprising:
a second steam nozzle coupled to the discharge diffuser for receiving steam from the discharge diffuser, the second steam nozzle having a narrowing cross-section so as to increase the velocity of the received steam;
a second discharge diffuser having an inner surface and a plurality of second vacuum ports positioned along the inner surface;
a second vacuum plenum positioned around an exterior surface of the second discharge diffuser and about the second vacuum ports and coupling the vacuum ports to the vacuum source, the second vacuum plenum and second vacuum ports configured for creating a vacuum through the second vacuum ports for withdrawing a portion of a fluid flow in the second discharge diffuser; and
a second flow control device coupled between the vacuum source and the second vacuum plenum and configured for adjusting the amount of vacuum and flow.
